(19) United States
(12) Patent Application Publication
(10) Pub. No.: US 2006/0267485 A1
(43) Pub. Date: Nov. 30, 2006

(54) Organic light emitting diode (oled) with contrast enhancement features

(76) Inventors: Richard P Wood, Waterford (CA); David J. Johnson, Toronto (CA)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/534,404

(22) PCT Filed: Nov. 12, 2003
(86) PCT No.: PCT/CA03/01742

§ 371 Date: May 26, 2006

(30) Foreign Application Priority Data
Nov. 13, 2002 (CA) 2,411,683

(51) Int. Cl. H05B 33/00

(52) U.S. Cl. 313/504; 313/506

(57) ABSTRACT

An organic electroluminescent device is provided having emitting layers with materials and thicknesses that provide constructive optical interference of emitted light. The device includes additional layers that provide contrast enhancement through destructive optical interference of ambient light entering the device.

### FIELD OF THE INVENTION

The present invention relates to electroluminescent devices, and more particularly relates to contrast enhancement filters that are applied to electroluminescent devices.

### BACKGROUND OF THE INVENTION

Known contrast enhancement filters include optical interference filters as described in U.S. Pat. No. 5,049,780 to Dobrowoiski and U.S. Pat. No. 6,411,019 to Hofstra, the contents of which are incorporated herein by reference. In certain teachings of Dobrowolski and Hofstra contrast enhancement is provided by an optical interference member that is placed in front of a reflective rear electrode or reflective rear cathode. As more particularly described therein, reflections of ambient light off of the rear electrode or rear cathode are used in conjunction with the optical interference member to create at least two, out-of-phase, wave forms of ambient light, which interfere with each other to cause at least some cancellation of each other and thereby reduce unwanted reflections of ambient light from the display.

Other known contrast enhancement filters include light absorbing materials that coat the reflective electrode or cathode. See, for example, WO 00/25028 to Berger et al, which contemplates the use of a graphite to coat a reflective rear cathode. These purely absorbing materials then reduce reflections of ambient light that enter the front of the display, by effectively converting that ambient light into heat.

However, these prior art structures may not be suitable where it is desired to actually utilize the reflectivity of the rear cathode in order to boost the amount of light emitted from the device. Put in other words, while the above-mentioned prior art devices reduce ambient light that reaches the rear cathode of the display, the prior art devices also tend to reduce the light that is backwardly emitted towards the rear of the display. Indeed, in certain prior art OLED displays it is known to select an appropriate emitting region portion of the light emitting layer, to cooperate with the reflective electrode, in order to achieve a total phase shift of rearwardly emitted light of about 360°, such that the two light waves constructively interfere, thereby enhancing the brightness of the device.

Presuming an ideal reflector and that the two light waves are thus equal in magnitude when they interfere, the intensity will be:
Irf=(Ef+Er)²
Ef=Er=E
Irf=4E², where Ef=electrical field of the forward emitted light and Er=electrical field of the rear emitted light, and Irf is the intensity seen by the viewer using a reflective rear electrode.

If Er is absorbed, as is the case with a dark electrode, the equations become simply:
Idk=(Ef+Er)²
Ef=E, Er=0
Idk=E², where Idk is the intensity seen by the viewer using a dark rear electrode. Thus Idk/Irf=¼=0.25 and the device using the dark rear electrode is only 25% as efficient as the device using the reflective rear electrode.

While it is known to reduce ambient light reflections in the above-described display using a circular polarizer applied to the front of the display, the circular polarizer has the additional effect of absorbing some of the emitted light, in some devices typically about 56 to about 62%, and in such devices the reflective rear electrode device is about 38% to about 44% efficient.

PCT/CA03/00554 entitled Electroluminescent Device discloses a partially absorbing (semi-reflecting) layer, one or more light-emitting layers, and a fully reflecting layer that, in combination, give rise to a 180° phase shift of ambient light, along with constructive interference of light generated in the light-emitting layers. However, as with the other prior art systems discussed above, back reflection of the light generated within the light emitting layers gives rise to destructive interference, which partially negates the advantages of the constructive interference.

### SUMMARY OF THE INVENTION

It is therefore an object of the present invention to provide a display with contrast enhancement feature that mitigates or obviates at least one of the above-identified disadvantages of the prior art.

In an aspect of the present invention, there is provided an electroluminescent display that embeds the light emitting layers within the optical interference structure itself.

In particular, light-emissive organic layers are disposes between a semi-reflecting structure and a reflective structure, wherein the thickness and material of the semi-reflecting structure is chosen to cause at least some destructive optical interference of ambient light, while the thickness of the layers between the semi-reflecting structure and fully reflective structures is chosen to provide net 0° phase shift of ambient light passing through those layers and reflected back, relative to the light reflected by the semi-reflecting structure. Moreover, the distance of the light-emitting region from the fully reflective surface is chosen to provide constructive interference of generated emitted light (i.e. emitted light rays travelling in the direction of the viewer are in phase with emitted light rays initially travelling away from the viewer and then fully reflected back toward the viewer).

### BRIEF DESCRIPTION OF THE DRAWINGS

Certain preferred embodiments of the present invention will now be explained, by way of example, with reference to the attached Figures in which:

FIG. 1 shows a side sectional view of light emitting and contrast enhancing layers of an organic electroluminescent device in accordance with a general aspect of the invention;

FIG. 2 shows a side sectional view of a bottom emission organic electroluminescent device in accordance with one embodiment of the invention; and

FIG. 3 shows a side sectional view of a top emission organic electroluminescent device in accordance with a further embodiment of the invention.

### DETAILED DESCRIPTION OF THE INVENTION

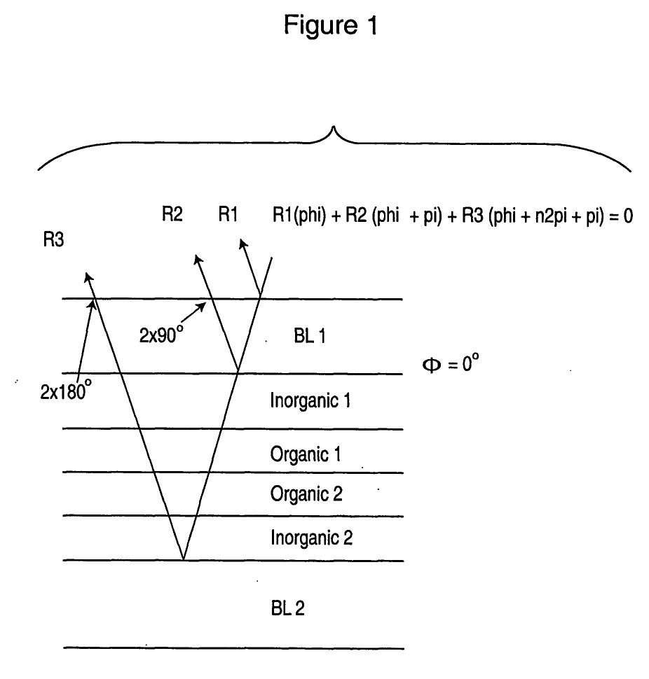

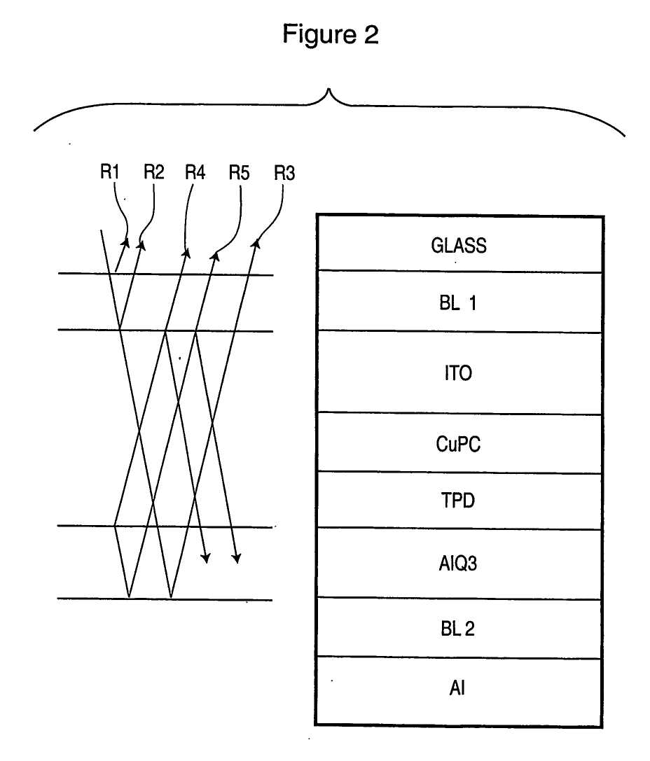

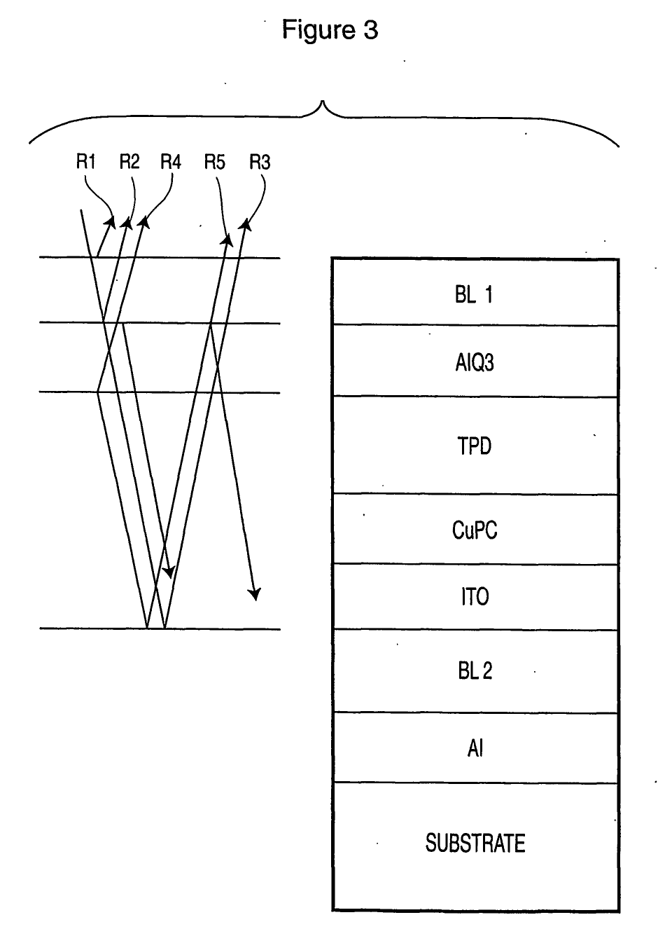

Referring now to FIG. 1, a semi-reflecting thin film BL 1 is disposed adjacent one side of a microcavity comprising inorganic layers such as ITO, AlSiO, etc. (identified in FIG. 1 as Inorganic 1, Inorganic 2) between which are disposed light emitting layers (identified as Organic 1, Organic 2), while a reflective structure BL 2 is disposed adjacent the opposite side of the microcavity. As discussed below in connection with FIGS. 2 and 3, the layer BL 2 may either be fully reflecting, or may instead partially transmit and phase shift light that is reflected off of a further fully reflective layer (e.g. Al layer). The light emitting layers generate light through electroluminescence and are fabricated from material that is nominally transparent to ambient light entering the device, and which causes a phase shift of that ambient light, as will be discussed in greater detail below.

Semi-reflecting structure BL 1 may comprise a single-layer film or a multi-layer film, as discussed in greater detail below, and serves two purposes:
1. It splits the incoming light into a reflected ray and a transmitted ray; and
2. It phase shifts the reflected light by about 180° relative to the light reflected from the rear electrode. Note that approximately 10-15% of the light is reflected back towards the viewer.

However, in order to achieve the destructive interference which leads to the device having low reflectance and thus appearing black, the total relative phase shift provided by the organic layers located between the semi-reflecting and reflecting thin films should be about 0°. This net 0° total phase shift occurs as the light travels two times through the organic layers: once as it is entering the structure and once upon reflection (i.e. 2×180°=360°=0°).

According to the invention, destructive interference of ambient light can be achieved while maintaining constructive interference conditions by choosing the total thicknesses of the organic layers and also any ITO or other inorganic layers, and BL 2 layers (where the BL 2 is only partially reflecting) to provide an approximate net 0° phase shift for light travelling through them, reflecting off of the rear cathode and travelling back out of the device, relative to the light reflected from the semi-reflecting structure in front, while independently controlling the distance between the emitting region at the interface of Organic 1, Organic 2 and the reflective rear electrode.

It should be noted that, in a single film BL 1 structure, light reflected from the first layer is reflected from both the front surface and the rear surface thereof. It is the resulting sum of these 180° phase shifted light rays that cancel, and thus the thickness of this layer is chosen to provide the 180° phase shift. In a multi-layer BL 1 structure, light is reflected from the first layer, phase shifted in the following layer(s), and then reflected off of the following layer(s).

In order to achieve a low reflectance value from the device of FIG. 1, the material of BL 1 will generally have some degree of absorption associated with it, i.e. an optical absorption constant k, whereas the optical density is defined by the index of refraction, n. The combination of n, k and thickness is chosen to achieve both the phase shift and the desired degree of reflection.

The combination of the absorption constant k, and the thickness of the BL 1 structure leads to light also being absorbed by the BL 1 structure. This leads to some of the emitted light being absorbed as it exits the device.

The semi-reflective structure BL1 can be located at various places within the device, provided that it is located between the viewer and the light emitting layers Organic 1 and Organic 2, and the total internal phase shift is about 0° relative to the light reflected from this first semi-reflective structure. For example, there is typically a layer of a transparent conductive material (Inorganic 1) within the device (e.g. Indium Tin Oxide) which serves to conduct current to the device as well as provide a means for the emitted light to escape the device and reach the viewer.

Also, semi-reflective structure BL 1 can be located between the viewer and the ITO, or the ITO can be located between the semi-reflective structure BL 1 and the viewer. Particularly in the latter case, the thickness of the ITO is not limited (though it may be selected in relation to desired electrical operation, such as to accord with the operating voltage of the device). In the first case the thickness of the ITO is taken into account to achieve the relative phase shift of about 0°.

It should also be noted that if the first semi-reflective layer of BL 1 were in contact with the organic layers of the device, these layers would also be selected to have an appropriate work function. On the other hand, a work-function matching layer can also be inserted as part of Inorganic 1, between the semi-reflecting layer and the organic layers.

The organic layers typically consist of a hole injection layer (e.g. TPD) and an electron injection layer (e.g. AlQ3), where light is generated at the interface therebetween. The location of these layers depends on whether the device is a “bottom emission device” (FIG. 2) in which the anode is located closest to the viewer, or a “top emission device” (FIG. 3) in which the cathode is located closest to the viewer. In either case, in SMOLED devices, the light emitting region is located within 50-200 Å of the interface of these two layers. For constructive interference of the emitted light to occur, the location of this interface relative to the reflective rear electrode is carefully chosen. For destructive interference to occur the total thickness of these layers is also carefully chosen. The various distances can be controlled as well by inserting layers of conductive organic material, typically CuPc, next to either the rear or front electrodes.

Finally, the reflective structure BL 2 consists of either a single layer of metal, for example Aluminum, or a thin film device of several layers, such as is known in the prior art and which can be tuned to a particular level of reflectance. In the simplest device most light is reflected back to interfere with the light reflected from the first semi-reflecting structure. In another embodiment the reflectivity of the thin film device of several layers can be tuned to ensure that the amplitude of the light reflected from this region is similar to the amplitude of the light reflected from the first semi-reflective structure, noting that some of the light will be absorbed as it passes through the semi-reflective structures.

Also, the light reflected from these rear layers can be phase shifted to enhance the light cancellation, and add a certain degree of freedom to the phase shifting requirements of the other layers, i.e. the organic stack and first semi-reflective structure.

In another embodiment specifically relating to the top emitting structure, the first semi-reflective structure can act as the electrode, eliminating the need for a transparent conducting material, such as ITO. It can also act as a buffer layer to protect underlying organic materials from damaging processes, such as described in commonly-owned Canadian Patent Application No. 2,412,379, entitled TRANSPARENT-CATHODE FOR TOP-EMISSION ORGANIC LIGHT-EMITTING DIODES, the contents of which are incorporated herein by reference.

If the semi-reflecting structure is located in the device in such a manner as to be conducting electricity, it is likely that structure will have to be patterned into the shape of the electrode it is in contact with. However, in another embodiment this structure may be electrically isolated from the structure through the use of an insulating layer. In a top emission structure this requires depositing an insulator on top of the front electrode and then depositing the semi-reflective structure. The thickness of the insulating layer is then taken into account in the phase shift of the transmitted light. In a bottom emission device the semi-reflective structure is deposited onto the substrate along with an insulating layer to isolate it from the front transparent electrode. Again, the thickness of the insulating layer is taken into account in the phase shift of the transmitted light. The advantage is that the semi-reflective structure is no longer required to be patterned and the optical interference effect occurs between pixels as well as on the pixels themselves.

In another embodiment, if the first semi-reflective structure is itself an insulator the insulating layers can be removed.

In a further embodiment, the organic materials may be comprised of light emitting polymers or inorganic light emitting materials.

Exemplary embodiments are shown in FIGS. 2 and 3 as follows:

Bottom Emission Device (FIG. 2):

The bottom emission device of FIG. 2 is fabricated on a substrate of glass or plastic. A semi-reflective (semi-absorbing) structure BL 1 is first deposited on the substrate, followed by a conductive layer of Indium Tin Oxide (ITO). Buffer layer CuPc is then deposited, followed by hole-carrier layer TPD and electron-carrier layer AlQ3. For consistency with FIG. 1, a second, fully reflective structure BL 2 is illustrated. However, in practice, the BL 2 structure may be eliminated since full reflection is provided by the final layer of aluminium.

As discussed above, the semi-reflective structure BL 1 partially reflects incident ambient light while partially transmitting ambient light. Ambient light is reflected off the outer surface to create reflected light ray R1. The transmitted light is phase shifted by 90° before partially reflecting off the interface between BL 1 and the ITO layer, whereupon the reflected light is subjected to a further 90° phase shift so that R2 is 180° out of phase with R1, causing destructive interference (i.e. cancellation of the reflected light). Ambient light transmitted through the ITO, CuPC, TPD and AlQ3 layers is subjected to a further 180+0 phase shift before reflecting off of the BL 2 (or Al) surface, whereupon the reflected light, is subjected to a further 180° phase shift, resulting in a net 360° phase shift between ambient light passing inward through the BL 1/ITO interface relative to ambient light passing outward through the BL 1/ITO interface. Consequently, R3 is similar in its phase characteristics to R2 (i.e. R3 is subjected to destructive interference with the incident ambient light). On the other hand, light generated within the organic layers (i.e. at the interface of hole layer TPD and electron layer AlQ3) is in phase (i.e. R4 ad R5 are in phase), so as to benefit from constructive interference.

Exemplary thicknesses and thickness ranges for the various structural layers are set forth below, wherein it will be noted that several of the layers are completely optional (i.e. thickness of 0). Nonetheless, the overall thickness and materials are chosen to ensure indices of refraction that give rise to a net 360°=0° phase shift for ambient light passing through the layers between BL 1 and the reflecting surface (i.e. BL 2 or Al). Equally importantly, the location of the light emissive region at the interface of the TPD and AlQ3 organic layers is chosen to ensure in-phase characteristics for light generated within that region and reflecting with the microcavity structure between the semi-reflective BL 1 structure and the fully reflective BL 2 or Al layer.

BL 1: Can be a wide range of materials and may comprise one or more layers. Typically the BL 1 structure consists of AlSiO (ratio 3:2, 5.5 nm), SiO2 (60 mm), and aluminum (10 nm)

ITO: Typical thickness is about 1200 Å, but within a range of about 0 to about 2500 Å.

CuPc: Typical thickness is about 250 Å, but within a range of about 0 to about 500 Å. The combined thickness of the ITO and CuPC layers should be about 1450 Å to provide a 180° phase shift on a single pass (assuming standard n, k values and that the organic materials (TPD and AlQ3) also provide a 180° phase shift).

TPD or Organic 1: preferably about 450 Å, but within a range of 200-500 Å.

AlQ3 or Organic 2: preferably about 600 Å, but with a range of 200-800 Å.

It should be noted that the sum of the thicknesses of ITO, CuPC, TPD and AlQ3 layers is preferably about 2500 Å to allow for a 360° phase shift on two passes (assuming standard n, k values) of emitted light. The buffer layer, e.g. CuPc, may be used to reduce the thicknesses of the two organic layers.

BL 2: A wide range of materials may be used, including Aluminum Silicon Monoxide. The ratio of aluminum to silicon monoxide must be altered to provide the desired reflectance values. In an optimal device the BL 2 structure may be omitted (i.e. thickness of 0 Å) to get maximum reflection from the rear cathode (Al), as discussed above.

Al: approximately 1500 Å.

Top Emission Device (FIG. 3):

In the top emission structure of FIG. 3, a substrate of glass or plastic is provided onto which a layer of aluminium is deposited to a thickness of about 1200 Å. Next, successive layers of ITO, CuPc, TPD and AlQ3 are deposited to the same thicknesses and approximate specifications as set forth above in connection with FIG. 2. Finally, the BL 1 structure is deposited in from one or more layers, as discussed above in connection with FIG. 1. A typical structure consists of AlSiO(ratio 3:2, 5.5 nm), SiO2 (60 nm), and aluminum (10 nm)

ITO can be used as BL 1 when the optical constants are tailored to meet the desired requirements of a semi-reflecting structure. Aluminum or silver doped ITO is known to increase absorption (conductivity increases as a by-product). In this case, the ITO is about 450 Å thick.

Presently preferred performance of both of the embodiments of FIGS. 2 and 3 is about 0% reflectance at about 555 nm of visible light, and about 45 to about 50% efficiency as compared to the ideal case of a tuned reflective cathode device without a circular polarizer.

The above-described embodiments of the invention are intended to be examples of the present invention and alterations and modifications may be effected thereto, by those of skill in the art For example, through careful material selection, the 360 degree phase shift effect (and the 180 degree destructive effect) can be made broadband, extending over the visible range. Specified materials must be selected that have a refractive index that increases with wavelength. AlSiO mixtures give a suitable material set. By inserting specific thicknesses of these materials into the microcavity (e.g. by replacing the ITO or part of the organic materials) the optical thickness of the cavities remains approximately constant for visible wavelengths, (i.e. 400 nm to 700 nm). All such modifications and alterations are believed to be within the scope of the invention as defined by the claims appended hereto.

1. An electroluminescent device, comprising a semi-reflecting structure, a reflecting structure, and a plurality of intermediate layers for light generation, wherein said semi-reflecting structure thickness is chosen to cause destructive optical interference of ambient light reflected thereby, and said intermediate layers have thicknesses chosen to create a microcavity for causing constructive optical interference of light generated therein and approximately 360° phase change of transmitted ambient light passing therethrough from said semi-reflecting structure and reflecting off said reflecting structure, such that said transmitted ambient light is subjected to further destructive optical interference within said semi-reflecting structure.

2. The electroluminescent device of claim 1, wherein said intermediate layers include a hole-carrier layer and electron-carrier layer with a light generating region at the interface therebetween.

3. The electroluminescent device of claim 2, wherein said hole-carrier layer comprises TPD and said electron-carrier layer comprises A1Q3.

4. The electroluminescent device of claim 3, wherein said intermediate layers include a buffer layer of CuPC adjacent said TPD layer.

5. The electroluminescent device of claim 4, wherein said intermediate layers include a conductive layer of ITO adjacent said CuPC layers.

6. The electroluminescent device of claim 5, wherein said thicknesses of the intermediate layers are as follows: A1Q3=200 to 800 Å, TPD=200 to 500 Å, CuPC=0 to 500 Å, ITO=0 to 2500 Å.

7. The electroluminescent device of claim 1, wherein said semi-reflecting structure comprises at least one layer of A1, SiO2 and Cr.

8. The electroluminescent device of claim 1, wherein said reflecting structure comprises a layer of A1.

9. The electroluminescent device of any of claim 1, wherein said reflecting structure is deposited on a substrate so as to form a top emission device.

10. The electroluminescent device of any of claim 1, wherein said semi-reflecting structure is deposited on a transparent substrate so as to form a bottom emission device.

11. The electroluminescent device of claim 10, wherein said substrate is one of either clear plastic or glass.

12. The electroluminescent device of claim 1, wherein said intermediate layers include one of either light emitting polymers or inorganic light emitting materials.

13. The electroluminescent device of claim 7, wherein said semi-reflecting structure comprises A1SiO (ratio 3:2, 5.5 nm), SiO2 (60 nm), and aluminum (10 nm).

14. The electroluminescent device of claim 6, wherein said thicknesses of the intermediate layers are as follows: A1Q3=600 Å, TPD=450 Å, CuPC=250 Å, ITO=1200 Å.

15. The electroluminescent device of claim 1, wherein said intermediate layers are selected such that the 360° phase change extends over the visible light range.

16. The electroluminescent device of claim 1, wherein the layers are selected to have a refractive index that increases with wavelength.

17. The electroluminescent device of any of claim 7, wherein said reflecting structure is deposited on a substrate so as to form a top emission device.

18. The electroluminescent device of any of claim 7, wherein said semi-reflecting structure is deposited on a transparent substrate so as to form a bottom emission device.

19. The electroluminescent device of any of claim 8, wherein said reflecting structure is deposited on a substrate so as to form a top emission device.

20. The electroluminescent device of any of claim 8, wherein said semi-reflecting structure is deposited on a transparent substrate so as to form a bottom emission device.
